(19) United States
(12) Patent Application Publication
(10) Pub. No.: US 2018/0274788 A1
(43) Pub. Date: Sep. 27, 2018

(54) ROTATING DETONATION ENGINE WAVE INDUCED MIXER

(71) Applicant: UNITED TECHNOLOGIES CORPORATION, Farmington, CT (US)

(72) Inventors: Christopher Britton Greene, East Hartford, CT (US); Adam Takashi Holley, Manchester, CT (US); Peter AT Cocks, East Hartford, CT (US)

(73) Assignee: UNITED TECHNOLOGIES CORPORATION, Farmington, CT (US)

(21) Appl. No.: 15/470,800

(22) Filed: Mar. 27, 2017

(51) Int. Cl. F23R 7/00; F02C 3/04

(52) U.S. Cl. CPC F23R 7/00; F02C 5/00; F05D 2240/35; F02C 3/04

(57) ABSTRACT

A rotating detonation engine includes an annulus that defines a volume having a detonation region which is configured for a mixture of an oxidizer and a fuel to detonate in a rotating fashion, the volume defining a downstream outlet through which detonation exhaust flows. The rotating detonation engine further includes an oxidizer outlet configured to output the oxidizer into the volume. The rotating detonation engine further includes a fuel outlet configured to output the fuel into the volume such that the oxidizer and the fuel are initially insufficiently mixed to facilitate combustion. The rotating detonation engine further includes an obstacle positioned upstream from the detonation region and configured to mix the fuel and the oxidizer that are directed upstream in response to a passing detonation.

### GOVERNMENT LICENSE RIGHTS

This disclosure was made with government support under contract N68936-15-C-0012 and awarded by the United States Defense Advanced Research Projects Agency. The government has certain rights in the disclosure.

### FIELD

The present disclosure is directed to rotating detonation engines and, more particularly, to a rotating detonation engine having an obstacle located upstream from a detonation region that is designed to improve mixing of fuel and air.

### BACKGROUND

Gas turbine engines include a compressor section, a turbine section, and a combustor section. The compressor section receives air from the environment and uses various rotors and stators to compress the air. The combustor section receives the compressed air and fuel, mixes the compressed air and fuel, and combusts the mixture to generate thrust. Exhaust from the combustor section is received by the turbine section which converts the exhaust into torque, a portion of which may be transferred to the compressor section. Recently, there has been research on the use of rotating detonation engines as combustors for gas turbine engines and other direct thrust applications such as ramjet and augmentor combustors. The detonations of rotating detonation engines rotate about the engine at a relatively great frequency. In that regard, it is desirable for the fuel and the oxidizer that combust during detonation to be relatively well mixed prior to the detonation reaching the mixture.

### SUMMARY

Disclosed herein is a rotating detonation engine. The rotating detonation engine includes an annulus that defines a volume having a detonation region which is configured for a mixture of an oxidizer and a fuel to detonate in a rotating fashion, the volume defining a downstream outlet through which detonation exhaust flows. The rotating detonation engine further includes an oxidizer outlet configured to output the oxidizer into the volume. The rotating detonation engine further includes a fuel outlet configured to output the fuel into the volume such that the oxidizer and the fuel are initially insufficiently mixed to facilitate combustion. The rotating detonation engine further includes an obstacle positioned upstream from the detonation region and configured to mix the fuel and the oxidizer that are directed upstream in response to a passing detonation.

In any of the foregoing embodiments, the obstacle has a face that faces towards the downstream outlet and extends towards a second wall of the annulus from a first wall of the annulus.

In any of the foregoing embodiments, the face forms an angle with the first wall of the annulus that is between 50 degrees and 120 degrees.

In any of the foregoing embodiments, the face is at least one of straight or concave.

In any of the foregoing embodiments, the oxidizer and the fuel are sufficiently mixed after the passing detonation to facilitate combustion.

In any of the foregoing embodiments, a fuel-air equivalence ratio of the oxidizer and the fuel after the passing detonation is selected based on an oxidizer type of the oxidizer, a fuel type of the fuel, a pressure experienced at a location of mixing, and a temperature experienced at the location of mixing.

In any of the foregoing embodiments, the fuel is injected into the volume in a direction that forms an angle with a first wall of the annulus that is between negative 90 degrees and 90 degrees.

In any of the foregoing embodiments, the fuel outlet includes a first fuel outlet coupled to a first wall of the annulus and a second fuel outlet coupled to a second wall of the annulus.

In any of the foregoing embodiments, the obstacle includes a first face that faces towards the downstream outlet and extends towards a second wall of the annulus from a first wall of the annulus, and a second face that faces towards the downstream outlet and extends towards the first wall of the annulus from the second wall of the annulus.

In any of the foregoing embodiments, the oxidizer is injected into the volume in a direction that forms an angle with a first wall of the annulus that is between negative 90 degrees and 90 degrees.

In any of the foregoing embodiments, the obstacle has an obstacle distance from a first wall of the annulus towards a second wall of the annulus that is equal to between 10 percent and 90 percent of an annulus distance from the first wall to the second wall.

Also described is a rotating detonation engine. The rotating detonation engine includes an annulus that defines a volume having a detonation region which is configured for a mixture of an oxidizer and a fuel to detonate in a rotating fashion, the volume defining a downstream outlet through which detonation exhaust flows. The rotating detonation engine further includes an oxidizer outlet configured to output the oxidizer into the volume at an oxidizer velocity. The rotating detonation engine further includes a fuel outlet configured to output the fuel into the volume at a fuel velocity that is within twenty five percent of the oxidizer velocity to create a relatively low shear relationship between the oxidizer and the fuel. The rotating detonation engine further includes a face located upstream from the detonation region, at least partially facing towards the downstream outlet, and configured to mix the fuel and the oxidizer that are directed upstream in response to a passing detonation.

In any of the foregoing embodiments, the face forms an angle with a first wall of the annulus that is between 50 degrees and 120 degrees.

In any of the foregoing embodiments, the face is at least one of straight or concave.

In any of the foregoing embodiments, a portion of the fuel fails to combust prior to being directed upstream in response to the passing detonation.

In any of the foregoing embodiments, the face includes a first face that extends towards a second wall of the annulus from a first wall of the annulus, and a second face that extends towards the first wall of the annulus from the second wall of the annulus.

Also described is a gas turbine engine. The gas turbine engine includes a turbine section configured to convert detonation exhaust into torque. The gas turbine engine also includes a compressor section configured to receive the torque from the turbine section and to utilize the torque to compress fluid. The gas turbine engine also includes a rotating detonation engine configured to generate the detonation exhaust. The rotating detonation engine includes an annulus that defines a volume having a detonation region which is configured for a mixture of an oxidizer and a fuel to detonate in a rotating fashion, the volume defining a downstream outlet through which detonation exhaust flows. The rotating detonation engine also includes an oxidizer outlet configured to output the oxidizer into the volume. The rotating detonation engine also includes a fuel outlet configured to output the fuel into the volume such that the oxidizer and the fuel are initially insufficiently mixed to facilitate combustion. The rotating detonation engine also includes an obstacle positioned upstream from the detonation region and configured to mix the fuel and the oxidizer that are directed upstream in response to a passing detonation.

In any of the foregoing embodiments, the obstacle has a face that faces towards the downstream outlet and extends towards a second wall of the annulus from a first wall of the annulus.

In any of the foregoing embodiments, the face is at least one of straight or concave and forms an angle with the first wall of the annulus that is between 50 degrees and 120 degrees.

In any of the foregoing embodiments, a portion of the fuel fails to combust prior to being directed upstream in response to the passing detonation.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed, non-limiting, embodiments. The drawings that accompany the detailed description can be briefly described as follows:

FIG. 1 is a schematic cross-section of a gas turbine engine having a rotating detonation engine, in accordance with various embodiments;

FIGS. 2A, 2B, and 2C are drawings illustrating various features of a rotating detonation engine, in accordance with various embodiments;

FIGS. 3A, 3B, and 3C are drawings illustrating rotation of the detonation of the rotating detonation engine of FIGS. 2A, 2B, and 2C, in accordance with various embodiments;

FIG. 4 is a drawing illustrating a rotating detonation engine having an obstacle located upstream from a detonation region for improving mixing of fuel and oxidizer, in accordance with various embodiments;

FIGS. 5A, 5B, 5C, 5D, and 5E are drawings illustrating rotating detonation engines having obstacles of various shapes for improving mixing of fuel and oxidizer, in accordance with various embodiments;

FIGS. 6A, 6B, and 6C are drawings illustrating rotating detonation engines having fuel outlets located in various locations, in accordance with various embodiments;

FIGS. 7A and 7B are drawings illustrating rotating detonation engines having obstacles with multiple faces for improving mixing of fuel and oxidizer, in accordance with various embodiments;

FIGS. 8A, 8B, and 8C are drawings illustrating rotating detonation engines having oxidizer outlets located in various locations, in accordance with various embodiments; and

FIGS. 9A and 9B are drawings illustrating rotating detonation engines having obstacles located on various walls of the rotating detonation engines, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact. Cross hatching lines may be used throughout the figures to denote different parts but not necessarily to denote the same or different materials.

As used herein, “aft” refers to the direction associated with the exhaust (e.g., the back end) of a gas turbine engine. As used herein, “forward” refers to the direction associated with the intake (e.g., the front end) of a gas turbine engine.

As used herein, “radially outward” refers to the direction generally away from the axis of rotation of a turbine engine. As used herein, “radially inward” refers to the direction generally towards the axis of rotation of a turbine engine.

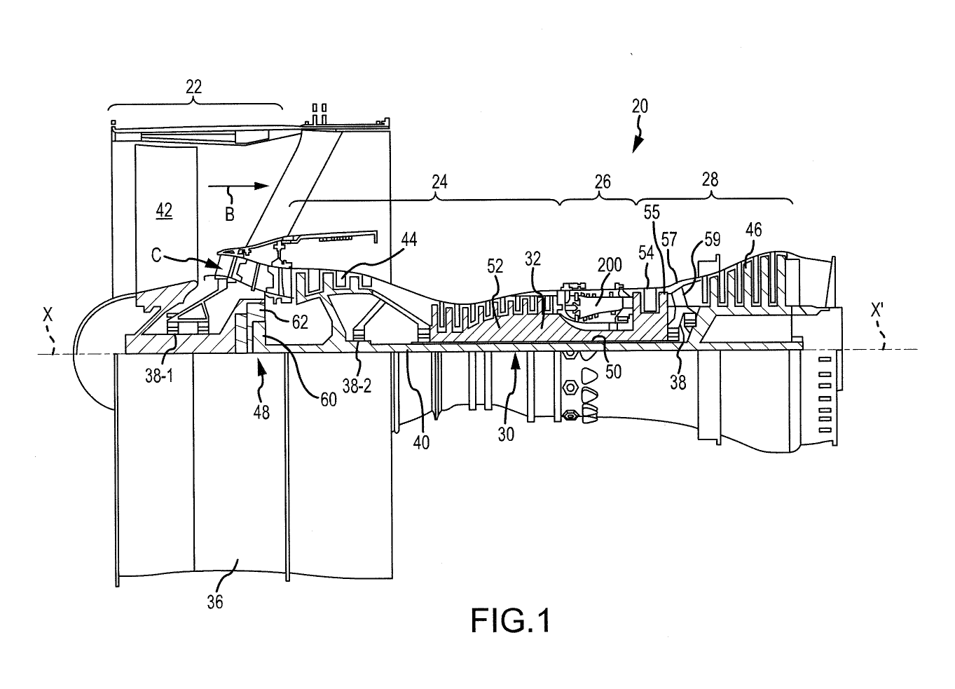

In various embodiments and with reference to FIG. 1, a gas turbine engine 20 is provided. The gas turbine engine 20 may be a two-spool turbofan that generally incorporates a fan section 22, a compressor section 24, a combustor section 26 and a turbine section 28. Alternative engines may include, for example, an augmentor section among other systems or features. In operation, the fan section 22 can drive coolant (e.g., air) along a bypass flow path B while the compressor section 24 can drive coolant along a core flow path C for compression and communication into the combustor section 26 then expansion through the turbine section 28. Although depicted as a two-spool turbofan gas turbine engine 20 herein, it should be understood that the concepts described herein are not limited to use with two-spool turbofans as the teachings may be applied to other types of turbine engines including turbojet, turboprop, turboshaft, or power generation turbines, with or without geared fan, geared compressor or three-spool architectures.

The gas turbine engine 20 may generally comprise a low speed spool 30 and a high speed spool 32 mounted for rotation about an engine central longitudinal axis A-A′ relative to an engine static structure 36 or engine case via several bearing systems 38, 38-1, and 38-2. It should be understood that various bearing systems 38 at various locations may alternatively or additionally be provided, including for example, the bearing system 38, the bearing system 38-1, and the bearing system 38-2.

The low speed spool 30 may generally comprise an inner shaft 40 that interconnects a fan 42, a low pressure compressor 44 and a low pressure turbine 46. The inner shaft 40 may be connected to the fan 42 through a geared architecture 48 that can drive the fan 42 at a lower speed than the low speed spool 30. The geared architecture 48 may comprise a gear assembly 60 enclosed within a gear housing 62. The gear assembly 60 couples the inner shaft 40 to a rotating fan structure. The high speed spool 32 may comprise an outer shaft 50 that interconnects a high pressure compressor 52 and high pressure turbine 54. A rotating detonation engine 200 may be located between high pressure compressor 52 and high pressure turbine 54. A mid-turbine frame 57 of the engine static structure 36 may be located generally between the high pressure turbine 54 and the low pressure turbine 46. Mid-turbine frame 57 may support one or more bearing systems 38 in the turbine section 28. The inner shaft 40 and the outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The airflow of core flow path C may be compressed by the low pressure compressor 44 then the high pressure compressor 52, mixed and burned with fuel in the rotating detonation engine 200, then expanded over the high pressure turbine 54 and the low pressure turbine 46. The turbines 46, 54 rotationally drive the respective low speed spool 30 and high speed spool 32 in response to the expansion.

The gas turbine engine 20 may be, for example, a high-bypass ratio geared engine. In various embodiments, the bypass ratio of the gas turbine engine 20 may be greater than about six (6). In various embodiments, the bypass ratio of the gas turbine engine 20 may be greater than ten (10). In various embodiments, the geared architecture 48 may be an epicyclic gear train, such as a star gear system (sun gear in meshing engagement with a plurality of star gears supported by a carrier and in meshing engagement with a ring gear) or other gear system. The geared architecture 48 may have a gear reduction ratio of greater than about 2.3 and the low pressure turbine 46 may have a pressure ratio that is greater than about five (5). In various embodiments, the bypass ratio of the gas turbine engine 20 is greater than about ten (10:1). In various embodiments, the diameter of the fan 42 may be significantly larger than that of the low pressure compressor 44, and the low pressure turbine 46 may have a pressure ratio that is greater than about five (5:1). The low pressure turbine 46 pressure ratio may be measured prior to the inlet of the low pressure turbine 46 as related to the pressure at the outlet of the low pressure turbine 46 prior to an exhaust nozzle. It should be understood, however, that the above parameters are exemplary of various embodiments of a suitable geared architecture engine and that the present disclosure contemplates other gas turbine engines including direct drive turbofans. A gas turbine engine may comprise an industrial gas turbine (IGT) or a geared engine, such as a geared turbofan, or non-geared engine, such as a turbofan, a turboshaft, or may comprise any gas turbine engine as desired.

In various embodiments, the low pressure compressor 44, the high pressure compressor 52, the low pressure turbine 46, and the high pressure turbine 54 may comprise one or more stages or sets of rotating blades and one or more stages or sets of stationary vanes axially interspersed with the associated blade stages but non-rotating about engine central longitudinal axis A-A′. The compressor and turbine sections 24, 28 may be referred to as rotor systems. Within the rotor systems of the gas turbine engine 20 are multiple rotor disks, which may include one or more cover plates or minidisks. Minidisks may be configured to receive balancing weights or inserts for balancing the rotor systems.

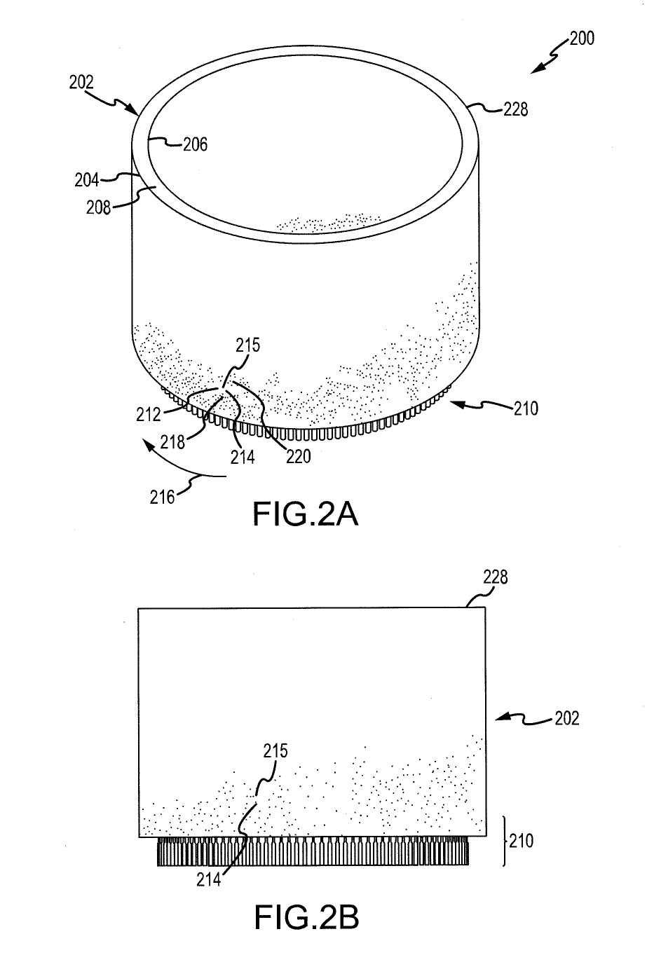

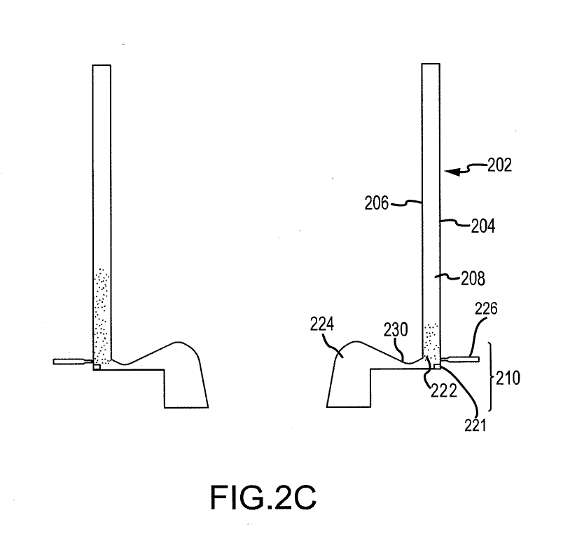

Referring now to FIGS. 2A, 2B, and 2C, the rotating detonation engine 200 may include an annulus 202 including an outer cylinder 204 and an inner cylinder 206. The outer cylinder 204 and the inner cylinder 206 may define a volume 208 therebetween. Although the rotating detonation engine 200 is shown as an annular structure, one skilled in the art will realize that a rotating detonation engine may have any shape that provides a continuous path for detonation to follow. For example, a rotating detonation engine may have an elliptical shape, a trapezoidal shape, or the like. In that regard, where used in this context, “annulus” may refer to any continuous circumferential channel having annular or any other shape such as trapezoidal or elliptical. Furthermore, where used herein, “annular volume” may likewise refer to any continuous circumferential channel having annular or any other shape such as trapezoidal or elliptical.

Furthermore, although the rotating detonation engine 200 is shown in use in a gas turbine engine, one skilled in the art will realize that a rotating detonation engine may be used as a combustor in any other system, such as a ramjet engine, an augmentor section of an engine, or the like.

A fuel mixer 210 may be positioned upstream from the annulus 202 and may provide a fuel mixture 212 including a combustible blend of an oxidizer and a fuel. The fuel mixture 212 may be continuously introduced into the volume 208. The rotating detonation engine 200 may then be initialized, causing a detonation 214 to occur. The detonation 214 corresponds to an ignition or combustion of the fuel mixture 212 at a particular location about a circumference of the annulus 202.

The detonation 214 may then continuously travel around the circumference of the annulus 202. As shown in FIG. 2A, the detonation 214 may occur at a location 215 and may travel in a direction illustrated by an arrow 216. A first location 218 within the volume 208 and preceding the detonation 214 may include a relatively large density of the fuel mixture 212. As the detonation 214 reaches the first location 218, the density of the fuel mixture 212 allows the fuel mixture 212 to detonate.

After the detonation occurs, the fuel mixture 212 may be burned away and the force of the detonation 214 may temporarily resist entry of additional fuel mixture 212 into the volume 208. Accordingly, a second location 220 that has recently detonated may have a relatively low density of the fuel mixture 212. In that regard, the detonation 214 may continue to rotate about the volume 208 in the direction shown by the arrow 216.

The detonation 214 may generate detonation exhaust. The rotating detonation engine 200 may include a downstream outlet 228 through which the detonation exhaust travels prior to reaching the turbine section 28 of FIG. 1. The detonation 214 will generate a pressure wave that travels upstream. Where used in this context, upstream refers to a direction towards the compressor section 24 of FIG. 1, and downstream refers to a direction towards the turbine section 28 of FIG. 1.

The fuel mixer 210 may be designed to blend and output the fuel mixture 212. In particular, the fuel mixer 210 may include a combustion channel 222, an oxidizer outlet 224, and a fuel outlet 226. The fuel mixer 210 may further include an obstacle 221 located upstream (towards the oxidizer outlet 224) from a location of detonation. The combustion channel 222, the oxidizer outlet 224, the fuel outlet 226, and the obstacle 221 may each include a metal or other material capable of withstanding relatively high temperatures such as one or more of an austenitic nickel-chromium-based alloy such as that sold under the trademark Inconel® which is available from Special Metals Corporation of New Hartford, N.Y., USA, or a stainless steel.

The oxidizer outlet 224 may output an oxidizer. The fuel outlet 226 may output a fuel. The fuel outlet 226 and the oxidizer outlet 224 may be positioned upstream from the combustion channel 222.

The oxidizer from the oxidizer outlet 224 and the fuel from the fuel outlet 226 may combine in the combustion channel 222 as the final mixture of the fuel and the oxidizer. The final mixture may be capable of detonation within one or both of the combustion channel 222 or the volume 208.

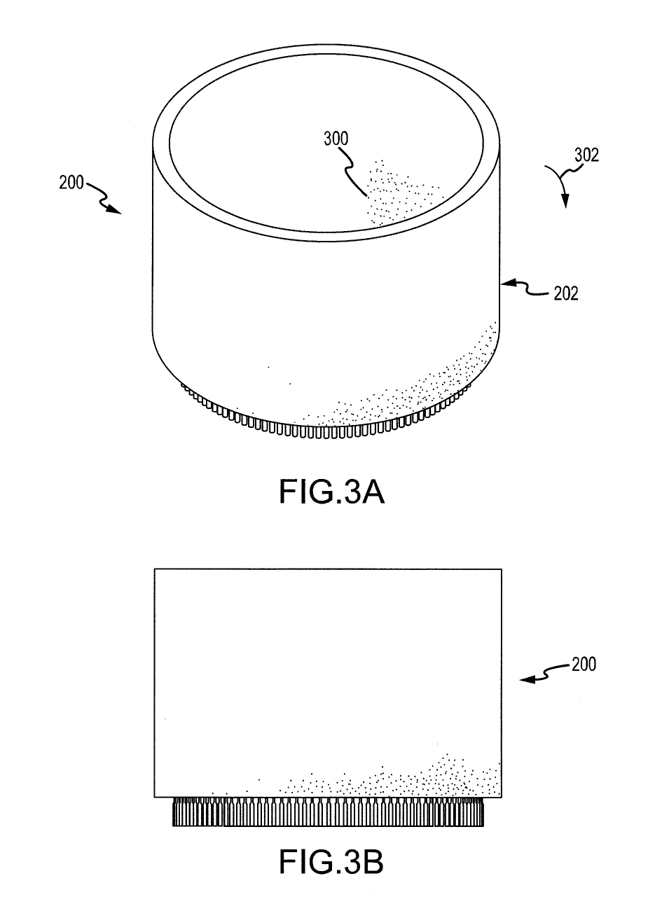

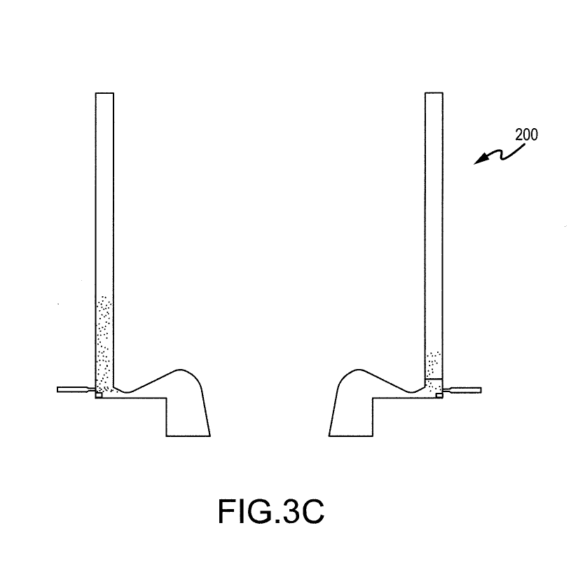

Referring now to FIGS. 3A, 3B, and 3C, the rotating detonation engine 200 is shown at a point in time later than shown in FIGS. 2A, 2B, and 2C. In particular, the rotating detonation engine 200 now has a detonation 300 at a different location than the detonation 214 of FIG. 2. As shown, the detonation 300 continues to travel counterclockwise about the annulus 202 as shown by an arrow 302. In various embodiments, a detonation of a rotating detonation engine may travel clockwise, counterclockwise, or both at the same time without departing from the scope of the present disclosure. In various embodiments, multiple detonation waves of the rotating detonation engine may travel simultaneously in the combustion chamber.

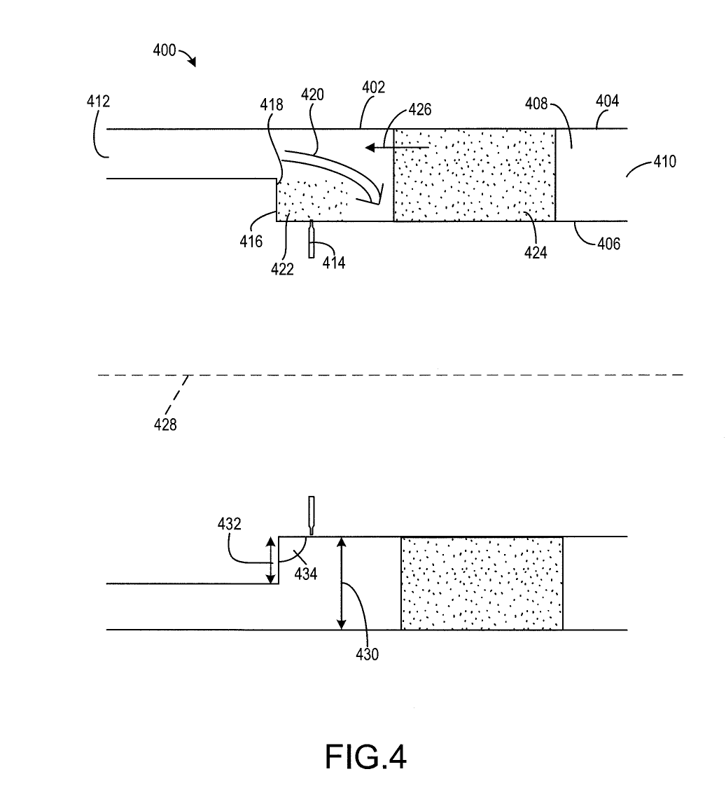

Turning now to FIG. 4, various features of a rotating detonation engine 400 are shown. The rotating detonation engine 400 includes an annulus 402 that is located circumferentially about a centerline 428. The annulus 402 includes a first wall 404, or outer wall, and a second wall 406, or inner wall. Although the outer wall is referred to as a first wall 404 and the inner wall is referred to as a second wall 406, a first wall may refer to either an inner wall or an outer wall, and a second wall may refer to the other of the inner wall or the outer wall.

The annulus 402 defines a volume 408 between the first wall 404 and the second wall 406 and a downstream outlet 410 through which combustion gases exit the volume 408. An oxidizer outlet 412 outputs an oxidizer into the volume 408, and a fuel outlet 414 outputs a fuel into the volume 408. The fuel and the oxidizer may mix within the volume 408 and may detonate in response to the rotating detonation reaching the mixture. An area of the annulus 402 may be referred to as a detonation region 424. The rotating detonation engine 400 may be designed such that the detonation of the mixture of the fuel and oxidizer occurs within the detonation region 424.

The rotating detonation engine 400 includes an obstacle 416 located upstream from the detonation region 424. The obstacle 416 includes a face 418 that is oriented downstream. Stated differently, the face 418 is facing the downstream outlet 410. The face 418 may be relatively straight as shown, or may be concave or convex. In various embodiments, the obstacle 416 may include multiple faces, but includes at least one face 418 that faces downstream.

The obstacle 416 may be designed to increase mixing of the fuel and the oxidizer. In various embodiments, the fuel and the oxidizer may be injected into the volume 408 in such a manner that they are initially insufficiently well mixed to facilitate combustion. For example, the fuel and the oxidizer may be injected in such a manner as to create a relatively low shear environment between the fuel and the oxidizer. For example, the fuel may be injected into the volume 408 at a fuel velocity, and the oxidizer may be injected into the volume 408 at an oxidizer velocity. The fuel velocity may be within 50 percent (50%), or 25%, or 15%, or 5% of the oxidizer velocity. Such velocity differential results in a relatively low shear relationship. In various embodiments, the fuel velocity and the oxidizer velocity may be relatively low in order to further reduce the shear within the volume 408.

Because relatively low shear exists within the volume 408, the fuel and the oxidizer may mix relatively poorly when first injected into the volume 408. Furthermore, a stream of oxidizer 420 may isolate a pocket of newly injected fuel 422 from the detonation region 424. In response to a passing detonation, the newly injected oxidizer and fuel, including the pocket of newly injected fuel 422, may be insufficiently mixed to facilitate combustion. As the detonation passes, a pressure wave is generated and travels upstream, in a direction indicated by an arrow 426. The pressure wave may force the stream of oxidizer 420 and the pocket of fuel 422 towards the face 418 of the obstacle 416, causing the oxidizer and the fuel to mix and reflect off the face 418. After such reflection, the mixture may travel downstream. Such force and reflection of the oxidizer and the fuel may cause the oxidizer and the fuel to become well mixed, facilitating combustion during a subsequent pass of the detonation.

The resulting mixture of the fuel and the oxidizer may have a fuel-air equivalence ratio. The fuel-air equivalence ratio of the resulting mixture may be selected based on an oxidizer type of the oxidizer, a fuel type of the fuel, a pressure experienced at the location of mixing, and a temperature experienced at the location of mixing.

The annulus 402 may have an annulus distance 430 that extends from the first wall 404 to the second wall 406. The obstacle may have an obstacle distance 432 in a direction parallel to the annulus distance 430. In various embodiments, the obstacle distance 432 may be between 10% and 90%, between 25% and 75%, or between 30% and 70% of the annulus distance 430. The face 418 may likewise form an angle 434 with the second wall 406. In various embodiments, the angle 434 may be between 15 degrees and 140 degrees, between 30 degrees and 120 degrees, or between 60 degrees and 110 degrees.

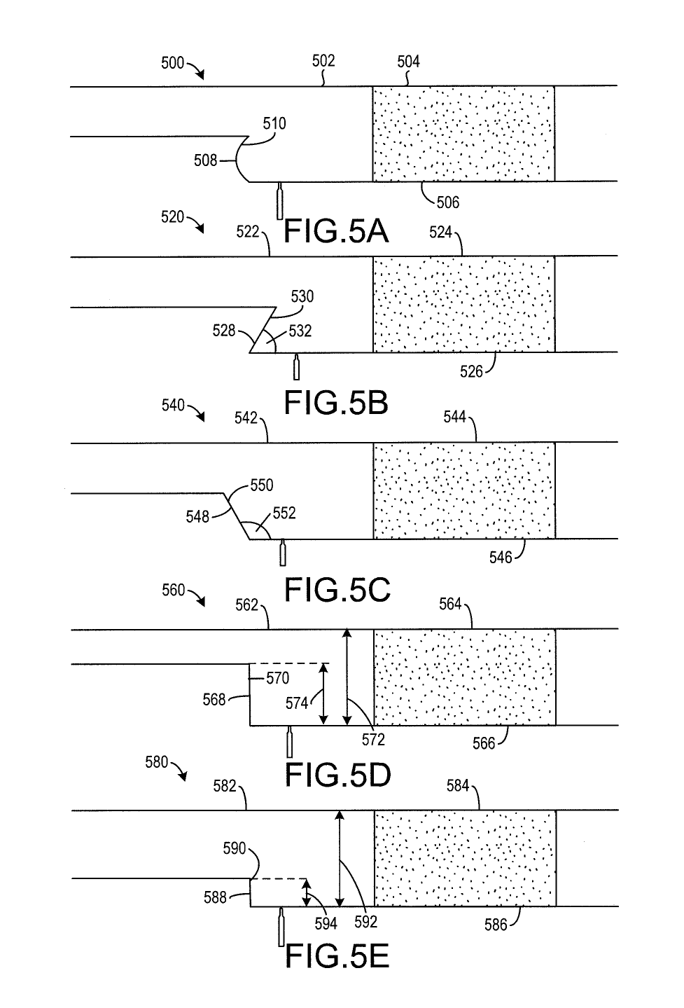

Turning now to FIGS. 5A through 5E, various embodiments of rotating detonation engines having obstacles for facilitating mixing of fuel and oxidizer are shown. FIG. 5A illustrates a first rotating detonation engine 500 having an annulus 502 with a first wall 504 and a second wall 506. The rotating detonation engine 500 further includes an obstacle 508. The obstacle 508 includes a face 510 that has a concave shape. The concave shape of the face 510 may facilitate mixing of oxidizer and fuel in response to a shockwave resulting from a passing detonation.

FIG. 5B illustrates a rotating detonation engine 520 having an annulus 522 with a first wall 524 and a second wall 526. The rotating detonation engine 520 further includes an obstacle 528. The obstacle 528 has a face 530. The face 530 forms an angle 532 with the second wall 526. The angle 532 may be less than 90 degrees, such as between 40 degrees and 89 degrees, between 50 degrees and 89 degrees, or the like.

FIG. 5C illustrates a rotating detonation engine 540 having an annulus 542 with a first wall 544 and a second wall 546. The rotating detonation engine 540 further includes an obstacle 548. The obstacle 548 has a face 550. The face 550 forms an angle 552 with the second wall 556. The angle 552 may be greater than 90 degrees, such as between 91 degrees and 130 degrees, between 91 degrees and 120 degrees, or the like.

FIG. 5D illustrates a rotating detonation engine 560 having an annulus 562 with a first wall 564 and a second wall 566. The rotating detonation engine 560 further includes an obstacle 568. The obstacle 568 has a face 570. An annulus distance 572 may exist between the first wall 564 and the second wall 566. The obstacle 568 may have an object distance 574 that is parallel to the annulus distance 572. As shown, the object distance 574 may be greater than 50% of the annulus distance 572. For example, the object distance 574 may be between 51% and 90%, between 51% and 80%, or between 51% and 75 of the annulus distance 572

FIG. 5E illustrates a rotating detonation engine 580 having an annulus 582 with a first wall 584 and a second wall 586. The rotating detonation engine 580 further includes an obstacle 588. The obstacle 588 has a face 590. An annulus distance 592 may exist between the first wall 584 and the second wall 586. The obstacle 588 may have an object distance 594 that is parallel to the annulus distance 592. As shown, the object distance 594 may be less than 50% of the annulus distance 592. For example, the object distance 594 may be between 10% and 49%, between 20% and 49%, or between 25% and 49 of the annulus distance 592.

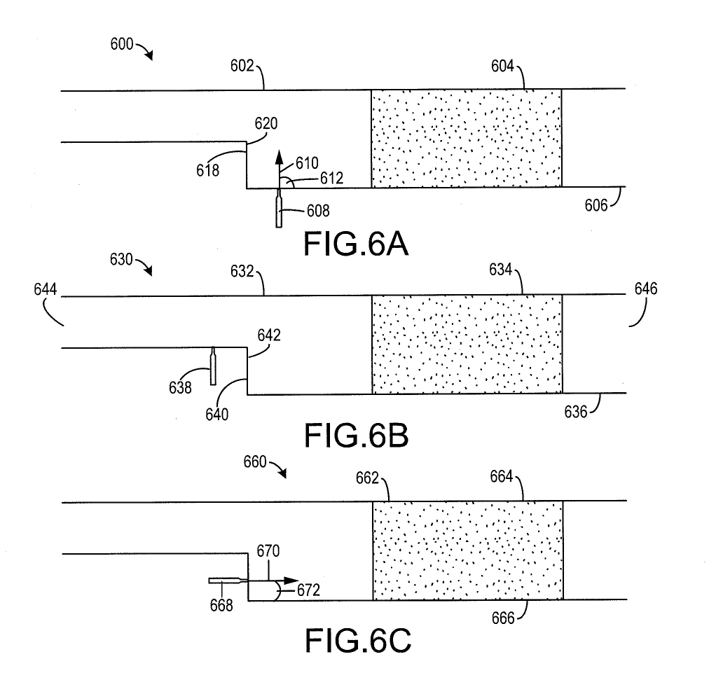

Referring to FIGS. 6A through 6C, various rotating detonation engines are shown. In particular, FIG. 6A illustrates a rotating detonation engine 600 having an annulus 602 with a first wall 604 and a second wall 606. The rotating detonation engine 600 further includes an obstacle 618 having a face 620. The rotating detonation engine 600 further includes a fuel outlet 608 that outputs fuel into the annulus 602 in a first direction 610. The fuel outlet 608 is positioned downstream from the obstacle 618. The direction 610 of fuel injection forms an angle 612 with the second wall 606. In various embodiments, the angle 612 may be between 0 degrees and 120 degrees, between 0 degrees and 90 degrees, or between 0 degrees and 45 degrees.

FIG. 6B illustrates a rotating detonation engine 630 having an annulus 632 with a first wall 634 and a second wall 636. The rotating detonation engine 630 further includes an obstacle 640 having a face 642. The rotating detonation engine 630 further includes a fuel outlet 638 that outputs fuel into the annulus 632. The fuel outlet 638 may be positioned upstream from the obstacle 618.

FIG. 6C illustrates a rotating detonation engine 660 having an annulus 662 with a first wall 664 and a second wall 666. The rotating detonation engine 660 further includes a fuel outlet 668 that outputs fuel into the annulus 662 in a direction 670. The direction 670 of fuel injection fauns an angle 672 with the second wall 606. In various embodiments, the angle 672 may be between negative 90 degrees and 90 degrees, negative 45 degrees and 45 degrees, or negative 30 degrees and 30 degrees.

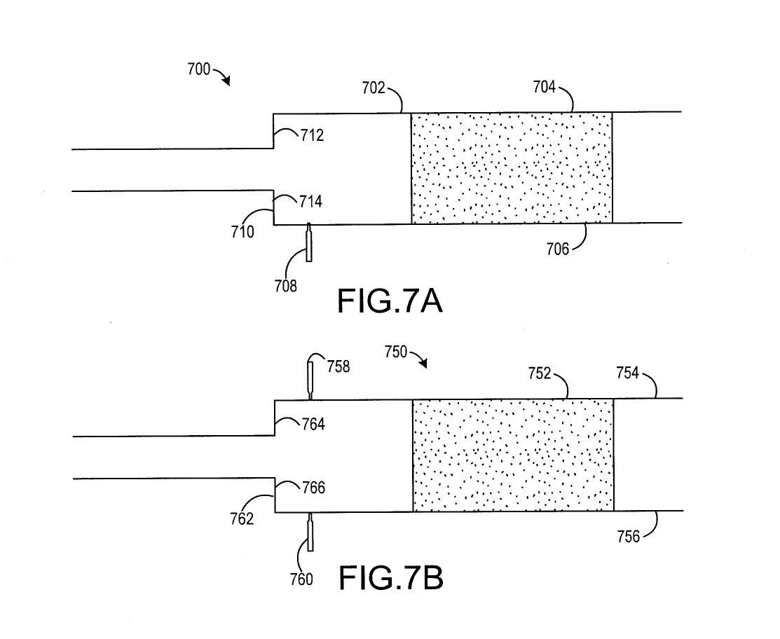

Referring to FIGS. 7A and 7B, a rotating detonation engine may include an obstacle having multiple faces. In particular, FIG. 7A illustrates a rotating detonation engine 700 having an annulus 702 with a first wall 704 and a second wall 706. The rotating detonation engine 700 further includes a fuel outlet 708 configured to inject fuel into the annulus 702 from the second wall 706. The rotating detonation engine 700 further includes an obstacle 710. The obstacle 710 has a first face 712 extending towards the second wall 706 from the first wall 704. The obstacle 710 further has a second face of 714 extending towards the first wall 704 from the second wall 706. The first face 712 and the second face 714 may each function to improve mixing of the fuel and the oxidizer within the annulus 702.

FIGS. 7B illustrates a rotating detonation engine 750 having an annulus 752 with a first wall 754 and a second wall 756. The rotating detonation engine 750 further includes a first fuel outlet 758 designed to inject fuel into the annulus 752 from the first wall 754 and a second fuel outlet 760 designed to inject fuel into the annulus 752 from the second wall 756. The rotating detonation engine 750 further includes an obstacle 762 having a first face 764 extending from the first wall 754 and a second face 766 extending from the second wall 756.

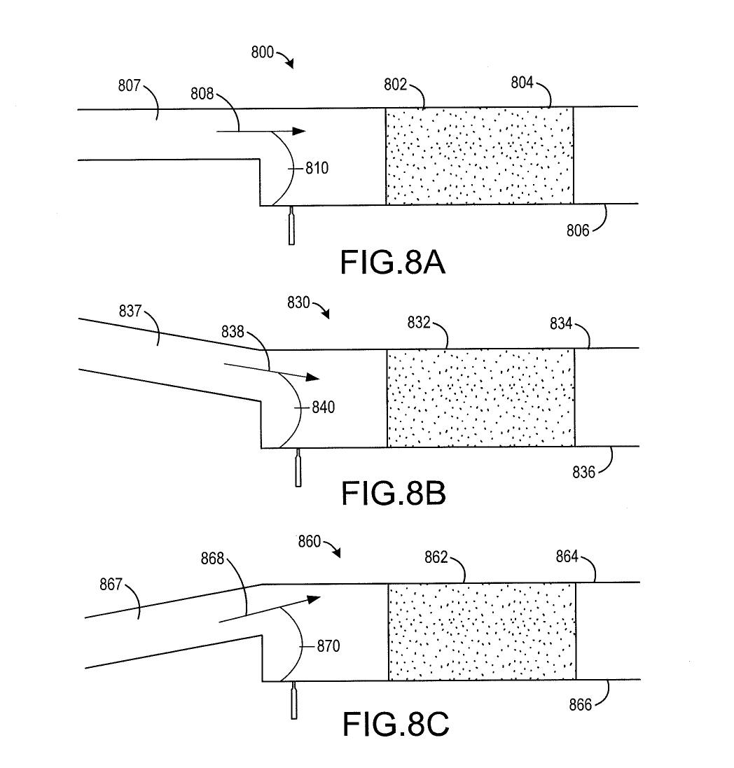

Referring now to FIGS. 8A through 8C, oxidizer may be injected into rotating detonation engines at various angles. FIG. 8A illustrates a rotating detonation engine 800 having an annulus 802 with a first wall 804 and a second wall 806. The rotating detonation engine 800 includes an oxidizer outlet 807 that injects oxidizer into the annulus 802. In particular, the oxidizer outlet 807 injects the oxidizer in a direction illustrated by an arrow 808. The direction of oxidizer injection may form an angle 810 with the second wall 806. In various embodiments, the angle 810 may be between negative 90 degrees and 90 degrees, negative 45 degrees and 45 degrees, or negative 30 degrees and 30 degrees.

FIG. 8B illustrates a rotating detonation engine 830 having an annulus 832 with a first wall 834 and a second wall 836. The rotating detonation engine 830 includes an oxidizer outlet 837 that injects oxidizer into the annulus 832. In particular, the oxidizer outlet 837 injects the oxidizer in a direction illustrated by an arrow 838. The direction of oxidizer injection may form an angle 840 with the second wall 836. In various embodiments, the angle 840 may be between negative 90 degrees and negative 1 degree, between negative 45 degrees and negative 1 degree, or between negative 30 degrees and negative 1 degree.

FIG. 8C illustrates a rotating detonation engine 860 having an annulus 862 with a first wall 864 and a second wall 866. The rotating detonation engine 860 includes an oxidizer outlet 867 that injects oxidizer into the annulus 862. In particular, the oxidizer outlet 867 injects the oxidizer in a direction illustrated by an arrow 868. The direction of oxidizer injection may form an angle 870 with the second wall 866. In various embodiments, the angle 870 may be between 1 degree and 90 degrees, 1 degree and 45 degrees, or 1 degree and 30 degrees.

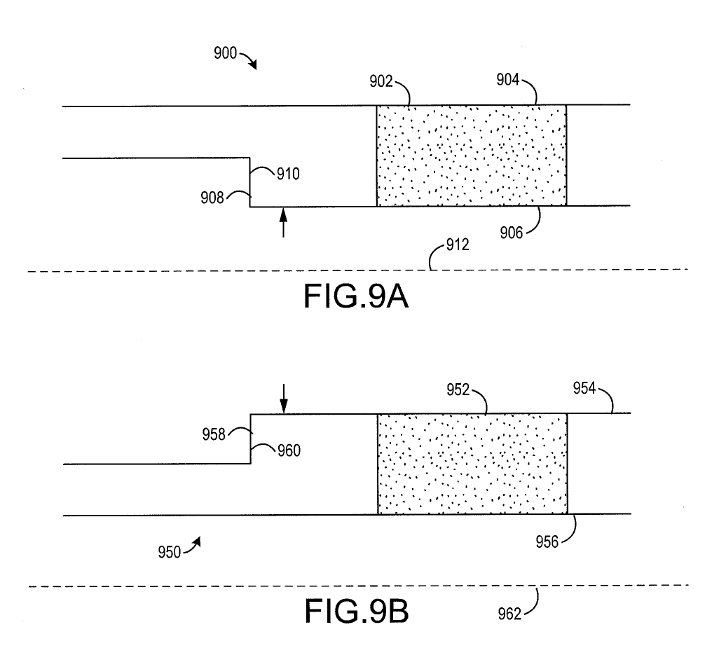

Referring to FIGS. 9A and 9B, and obstacle of a rotating detonation engine may be positioned on an inner wall or an outer wall. For example and referring to FIG. 9A, a rotating detonation engine 900 includes an annulus 902 having a center line 912. The annulus 902 has an outer wall 904 and an inner wall 906. The rotating detonation engine 900 further includes an obstacle 908 having a face 910. The obstacle 908 may be positioned on the inner wall 906 and extend towards the outer wall 904 from the inner wall 906.

FIG. 9B illustrates a rotating detonation engine 950 that includes an annulus 952 having a center line 962. The annulus 952 has an outer wall 954 and an inner wall 956. The rotating detonation engine 950 further includes an obstacle 958 having a face 960. The obstacle 958 may be positioned on the outer wall 954 and extend from the outer wall 954 towards the inner wall 956.

While the disclosure is described with reference to exemplary embodiments, it will be understood by those skilled in the art that various changes may be made and equivalents may be substituted without departing from the spirit and scope of the disclosure. In addition, different modifications may be made to adapt the teachings of the disclosure to particular situations or materials, without departing from the essential scope thereof The disclosure is thus not limited to the particular examples disclosed herein, but includes all embodiments falling within the scope of the appended claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of a, b, or c” is used in the claims, it is intended that the phrase be interpreted to mean that a alone may be present in an embodiment, b alone may be present in an embodiment, c alone may be present in an embodiment, or that any combination of the elements a, b and c may be present in a single embodiment; for example, a and b, a and c, b and c, or a and b and c. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A rotating detonation engine, comprising:
an annulus that defines a volume having a detonation region which is configured for a mixture of an oxidizer and a fuel to detonate in a rotating fashion, the volume defining a downstream outlet through which detonation exhaust flows;
an oxidizer outlet configured to output the oxidizer into the volume;
a fuel outlet configured to output the fuel into the volume such that the oxidizer and the fuel are initially insufficiently mixed to facilitate combustion; and
an obstacle positioned upstream from the detonation region and configured to mix the fuel and the oxidizer that are directed upstream in response to a passing detonation.

2. The rotating detonation engine of claim 1, wherein the obstacle has a face that faces towards the downstream outlet and extends towards a second wall of the annulus from a first wall of the annulus.

3. The rotating detonation engine of claim 2, wherein the face forms an angle with the first wall of the annulus that is between 50 degrees and 120 degrees.

4. The rotating detonation engine of claim 2, wherein the face is at least one of straight or concave.

5. The rotating detonation engine of claim 1, wherein the oxidizer and the fuel are sufficiently mixed after the passing detonation to facilitate combustion.

6. The rotating detonation engine of claim 5, wherein a fuel-air equivalence ratio of the oxidizer and the fuel after the passing detonation is selected based on an oxidizer type of the oxidizer, a fuel type of the fuel, a pressure experienced at a location of mixing, and a temperature experienced at the location of mixing.

7. The rotating detonation engine of claim 1, wherein the fuel is injected into the volume in a direction that forms an angle with a first wall of the annulus that is between negative 90 degrees and 90 degrees.

8. The rotating detonation engine of claim 1, wherein the fuel outlet includes a first fuel outlet coupled to a first wall of the annulus and a second fuel outlet coupled to a second wall of the annulus.

9. The rotating detonation engine of claim 1, wherein the obstacle includes a first face that faces towards the downstream outlet and extends towards a second wall of the annulus from a first wall of the annulus, and a second face that faces towards the downstream outlet and extends towards the first wall of the annulus from the second wall of the annulus.

10. The rotating detonation engine of claim 1, wherein the oxidizer is injected into the volume in a direction that forms an angle with a first wall of the annulus that is between negative 90 degrees and 90 degrees.

11. The rotating detonation engine of claim 1, wherein the obstacle has an obstacle distance from a first wall of the annulus towards a second wall of the annulus that is equal to between 10 percent and 90 percent of an annulus distance from the first wall to the second wall.

12. A rotating detonation engine, comprising:
an annulus that defines a volume having a detonation region which is configured for a mixture of an oxidizer and a fuel to detonate in a rotating fashion, the volume defining a downstream outlet through which detonation exhaust flows;
an oxidizer outlet configured to output the oxidizer into the volume at an oxidizer velocity;
a fuel outlet configured to output the fuel into the volume at a fuel velocity that is within twenty five percent of the oxidizer velocity to create a relatively low shear relationship between the oxidizer and the fuel; and
a face located upstream from the detonation region, at least partially facing towards the downstream outlet, and configured to mix the fuel and the oxidizer that are directed upstream in response to a passing detonation.

13. The rotating detonation engine of claim 12, wherein the face forms an angle with a first wall of the annulus that is between 50 degrees and 120 degrees.

14. The rotating detonation engine of claim 12, wherein the face is at least one of straight or concave.

15. The rotating detonation engine of claim 12, wherein a portion of the fuel fails to combust prior to being directed upstream in response to the passing detonation.

16. The rotating detonation engine of claim 12, wherein the face includes a first face that extends towards a second wall of the annulus from a first wall of the annulus, and a second face that extends towards the first wall of the annulus from the second wall of the annulus.

17. A gas turbine engine, comprising:
a turbine section configured to convert detonation exhaust into torque;
a compressor section configured to receive the torque from the turbine section and to utilize the torque to compress fluid; and
a rotating detonation engine configured to generate the detonation exhaust and having:
an annulus that defines a volume having a detonation region which is configured for a mixture of an oxidizer and a fuel to detonate in a rotating fashion, the volume defining a downstream outlet through which the detonation exhaust flows,
an oxidizer outlet configured to output the oxidizer into the volume,
a fuel outlet configured to output the fuel into the volume such that the oxidizer and the fuel are initially insufficiently mixed to facilitate combustion, and
an obstacle positioned upstream from the detonation region and configured to mix the fuel and the oxidizer that are directed upstream in response to a passing detonation.

18. The gas turbine engine of claim 17, wherein the obstacle has a face that faces towards the downstream outlet and extends towards a second wall of the annulus from a first wall of the annulus.

19. The gas turbine engine of claim 18, wherein the face is at least one of straight or concave and forms an angle with the first wall of the annulus that is between 50 degrees and 120 degrees.

20. The gas turbine engine of claim 17, wherein a portion of the fuel fails to combust prior to being directed upstream in response to the passing detonation.
